(19) United States
(12) Patent Application Publication
(10) Pub. No.: US 2007/0073574 A1
(43) Pub. Date: Mar. 29, 2007

(54) Network marketing system

(75) Inventor: H. Edward Young JR., Bloomfield, NJ (US)

Correspondence Address: LERNER, DAVID, LITTENBERG,;KRUMHOLZ & MENTLIK, 600 SOUTH AVENUE WEST, WESTFIELD, NJ, 07090, US

(73) Assignee: EverYoung Media, LLC, Bloomfield, NJ (US)

(21) Appl. No.: 11/433,600

(22) Filed: May 12, 2006

Related U.S. Application Data
(60) Provisional application No. 60/719,794, filed on Sep. 23, 2005.

(51) Int. Cl. G06F 15/02

(52) U.S. Cl. 705/9

(57) ABSTRACT

A network marketing system wherein an online vendor enables users to send offers to friends or acquaintances and then rewards the users if the friends or acquaintances accept the offer. The system allows the vendor to market to new users while relying on current users of the system to find others that are interested in the goods or services that the vendor provides.

### CROSS-REFERENCE TO RELATED APPLICATION

The present application claims the benefit of the filing date of U.S. Provisional Application No. 60/719,794, filed Sep. 23, 2005, the disclosure of which is hereby incorporated by reference herein.

### BACKGROUND OF THE INVENTION

This invention relates to systems for facilitating marketing and sales over a network and in particular, the Internet.

The Internet has revolutionized the way consumers shop for goods and services. Electronic commerce has become the new paradigm for many businesses because of the low overhead involved with running an Internet-based business.

Online advertising for these electronic vendors, or vendors who sell goods or services on the Internet, is ubiquitous throughout the Internet and provides information and quite often the ability to contact the electronic commerce vendor directly. Thus, when a user is navigating through various Internet sites the user is bombarded with advertisements for electronic vendors.

Electronic vendors often also resort to e-mail advertisements. These advertisements are often mailed to large numbers of recipients and are colloquially known as “spam.” Because of the low cost of e-mail advertising, the number of e-mail advertisements that are sent to users of the Internet is staggering. Thus, users of e-mail systems typically ignore nearly all advertisements sent by e-mail if they do not recognize the source, or sender, of the e-mail.

Commonly used e-mail systems such as Yahoo, Gmail and MS Hotmail usually have built-in spam filters. These filters are in place to automatically detect e-mails sent to users from senders or companies that are not in the user's contact list. This means that the user may never see most advertisements that are sent to the user because the filter will remove the e-mail messages or segregate the e-mail messages into a designated folder for unauthorized mail. These filters prevent unsolicited e-mail advertisements from ever reaching the user. This inhibits the ability of companies to reach out to new consumers using e-mail advertisements with special offers for the new customers.

It is similarly difficult for electronic vendors to reach new customers using Internet-based advertisements such as banner advertisements. Most advertisements, such as banner advertisements, are featured on the sides or tops of high traffic web pages, such as search engines or Internet news sites. These advertisements typically comprise a special offer or a feature product. A user who sees the advertisement may click on the advertisement to visit the electronic vendor's web site where they may purchase the advertised goods or services. The great number of these advertisements that are present on the Internet, however, reduces the effectiveness of the advertisements. For example, frequent users of the Internet search engine Google are aware that advertisements are shown on the right side of the Google screen and they therefore routinely ignore the right side of the screen when performing searches.

Thus, there exists a need for a new advertising system and method for use on networks, and in particular the Internet, that allows electronic vendors to transmit advertisements and offers to potential new customers.

### SUMMARY OF THE INVENTION

The present invention was designed to address the foregoing problems.

In one embodiment, the present invention comprises a computer-implemented method of marketing comprising sending a first offer for goods or services from a vendor over a network to a first user, forwarding the first offer by the first user over the network to one or more first offerees, awarding a first predetermined amount of points to the first user upon the one or more first offerees accepting the first offer from the vendor, forwarding a second offer by the one or more first offerees to one or more second offerees, and awarding the one or more first offerees and the first user a second predetermined amount of points upon one or more second offerees accepting the second offer. In one embodiment, the first user may redeem point for goods or services from the vendor. In another embodiment, the first user may redeem the points for currency.

The first offer may include a code so that the first offer can be traced back to the first user if any of the first offerees accept the first offer.

In one embodiment, the first user is restricted to forwarding the offer to only a predetermined number of first offerees.

The first predetermined amount of points may be calculated using the value of the goods or services purchased by the offeree.

Any user from the second set of offerees that accepts the second offer may be designated the third user. The third user may then forward a third offer from the vendor to a third set of offerees comprising one or more offerees and a predetermined amount of points will be awarded to the second user and the third user if any offeree from the third set of offerees accepts the third offer from the vendor. In one embodiment, the first user will be awarded points if any offeree from the third set of offerees accepts the third offer from the vendor.

In one embodiment, the method may further comprise creating a user profile by the first user containing information about the user, and storing the user profile. A user profile may be created by any one of the first offerees or the second offerees upon acceptance of the first offer or the second offer from the vendor and stored on the system.

In another embodiment, the present invention comprises a system for marketing comprising a vendor computer including a processor programmed to offer products or services to a plurality of users over a network and a points computer including a processor programmed to communicate with the vendor computer over the network, record profiles and transaction histories for at least one user, and enable the at least one user to send offers for goods or services from the vendor computer to a group of users.

The processor of the points computer is preferably further programmed to award points to a user if the user sends an offer for goods or services to a second user that accepts the offer. The processor of the points computer is preferably programmed to award points based on the dollar value of the goods or services sold.

The processor of the vendor computer is programmed to communicate with the at least one user through a web site. The processor of the vendor computer is preferably programmed to provide recommendations for goods or services to the at least one user based on the transaction history of the at least one user.

The processor of the vendor computer preferably includes a database of offers, the database being searchable by the at least one user.

The system may further comprise a debit card which stores a value corresponding to the amount of points the at least one user has in his or her account. In an alternative embodiment, the system may comprise a credit card that causes the deduction of points from the at least one user's account when used for purchases.

In another embodiment, the present invention comprises a computer-implemented method of marketing comprising sending a first offer for goods or services from a vendor computer to a first user, accepting the first offer from the vendor computer by the first user, forwarding the first offer from the vendor computer to one or more first offerees from the first user, accepting the first offer by one or more first offerees from the vendor computer, awarding a first predetermined amount of points to an account on a points computer corresponding to the first user if the one or more first offerees accepting the first offer, forwarding a second offer by the first offerees from a vendor computer to one or more second offerees, and awarding the one or more first offerees and the first user a second predetermined amount of points to an account on a points computer upon one or more second offerees accepting the second offer.

In another embodiment, the present invention comprises a system for marketing comprising a vendor computer including a processor programmed to offer products or services to a plurality of users over a network, wherein the vendor computer is adapted to store profiles for the plurality of users including information about the users and prior transactions conducted by the users, and the processor of the vendor computer is adapted to send offers for goods or services from a selected user of the plurality of users to offerees and awards points to the selected user if any of the offerees accept the offer.

In another embodiment, the present invention comprises a storage medium storing a program executable by a processor, wherein the program causes the processor to send a first offer for goods or services from a vendor over a network to a first user, forward the first offer from the first user over a network to one or more first offerees, and award a first predetermined amount of points to the first user upon the one or more first offerees accepting the first offer from the vendor, wherein the offerees can forward a second offer to one or more second offerees, and awarding the one or more first offerees and the first user a second predetermined amount of points upon one or more second offerees accepting the second offer.

### BRIEF DESCRIPTION OF THE DRAWINGS

FIG. 1 is a diagram of the various components that may be used in a preferred embodiment of the present invention.

FIG. 1A is a diagram of the various components that may be used in an alternative embodiment of the present invention.

FIG. 1B depicts the various elements of a points system in a preferred embodiment of the invention.

FIG. 1C depicts an e-mail containing an offer in a preferred embodiment of the invention.

FIGS. 2-4 depict a flow diagram in accordance with an embodiment of the present invention.

### DETAILED DESCRIPTION

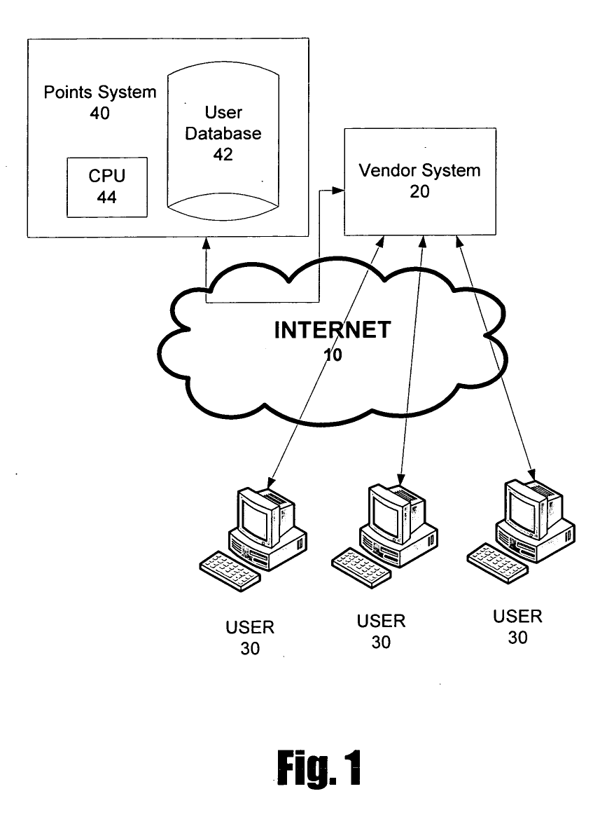

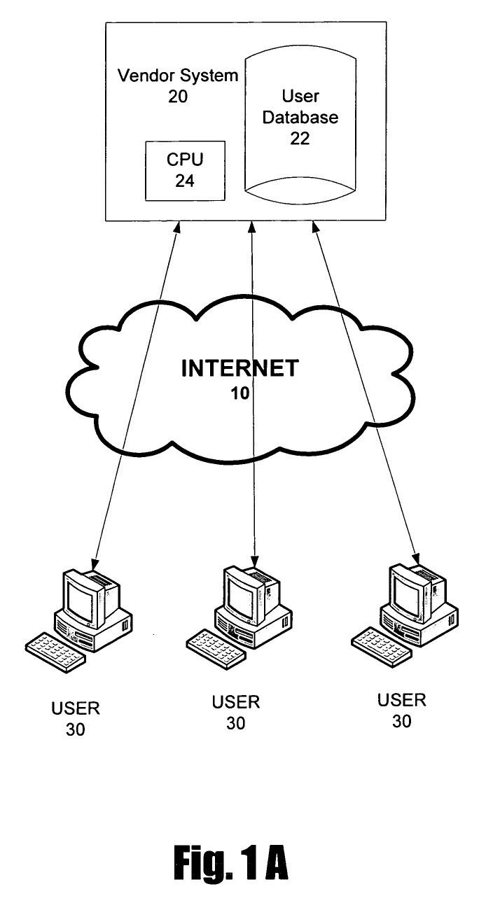

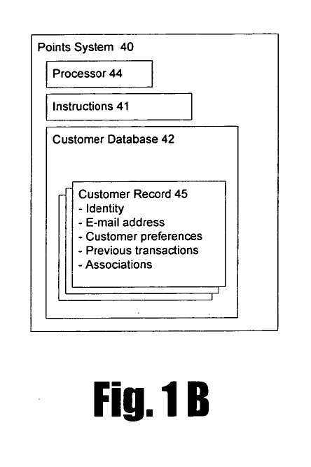

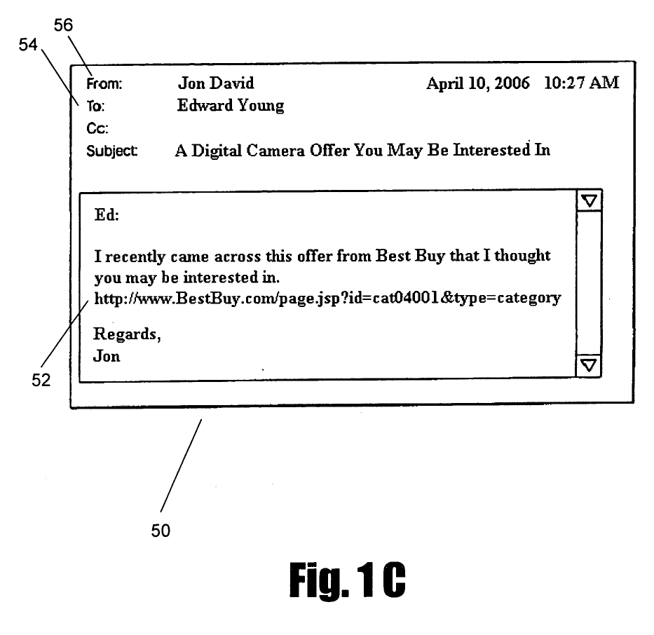

FIG. 1 depicts various hardware components used in a preferred embodiment of the invention. In general, the present invention is operable on a plurality of computers which are preferably at different physical locations. The various computers preferably communicate with each other and may be connected to each other over a network, such as the Internet. In alternate embodiments, the computers may communicate with each other directly without the use of a network. The invention preferably utilizes at least one user computer which allows users to access at least one vendor system. The at least one vendor system may utilize a points system for keeping track of points used in the system.

Users 30 may be located anywhere throughout the world and access the vendor system 20 through the Internet 10. Users preferably access the vendor systems using user computers. The user computer preferably includes at least one input device such as a keyboard or mouse, at least one output device or display such as a monitor, a volatile memory and a non-volatile memory. The user computer preferably includes a processor, such as a microprocessor, for executing software programs and random access memory for running programs. The vendor system preferably has one or more servers, including processors which allow it to execute software or programs that carry out the various processes of the present invention. The vendor system 20 preferably also has a memory, such as random access memory, which in connection with the microprocessor, runs software to allow various processes to be performed, such as the tracking and rewarding of points as discussed below. Vendor system 20 preferably communicates with the points system 40 through the Internet 10. The points system 40 contains a user database 42 and a CPU 44. The user database contains a profile for each of the users and preferably includes user information such as name, address, and previous purchases from the vendor. The user database preferably also keeps track of each user's reward points, which are explained in more detail below.

The setup depicted in FIG. 1 is advantageous to an online vendor because the vendor does not have to maintain the software and databases necessary to track a user's points. The vendor system 20 simply communicates with the points system 40 through the Internet or directly to track the points of a user or to provide transaction information relevant to a user. The vendors may preferably work with the points system to set up and manage their own preferences for the maintenance of user points.

In an alternate embodiment shown in FIG. 1A, the vendor system 20 contains its own user database 22 and CPU 24 for tracking a user's points. This setup may be used if an online vendor wishes to track the points of a user without the need for a third party or if the vendor simply wants to design their own points system. Although two different configurations are depicted for this system, many different hardware configurations may be used including but not limited to the direct connection of the various computers used in the system without the use of a network.

In one embodiment, the points system maintains a database of current customers, such as customers who have purchased goods or services from a specific vendor or selected vendors in the past. One embodiment of the database is depicted as part of a points system 40 in FIG. 1B, which shows the points system 40 as containing a processor 44, instructions 41 such as a computer program to instruct the processor, and a customer database 42. The customer database 42 preferably contains a plurality of customer records 45. Each customer record preferably contains information about the customer, such as the customer's name, e-mail address, and previous transactions. The customer record preferably also contains the associations of the customer, meaning other users that the customer has sent offers to or accepted offers from. The customer record may also include the preferences of the customer, such as the tracking of points in dollar form or the display of the number of offers a user has outstanding.

The points system or the vendor may maintain a list of customers who consent to be contacted with special offers. The vendor or the points system sends an e-mail to these customers, or alternatively to all customers, with a special offer. The users who receive the special offer for goods or services provided by a vendor are instructed to then forward the offer by e-mail to friends, acquaintances, or other individuals that the users believe would be interested in the offer. The e-mail from the vendor or the points system to the users informs the users that they will be rewarded points if they forward the offer to someone who accepts the offer. The e-mail itself may contain the offer from the vendor and a link to the vendor's website where the offeree can accept the offer. The offer may remain open for a predetermined amount of time set by the vendor or indefinitely.

Alternatively, the e-mail sent by the vendor or the points system to the user may contain a link back to the vendor's website where the user can log into their profile and enter the e-mail addresses of offerees that they believe would be interested in the offer. One embodiment of an e-mail containing a link to an offer is depicted in FIG. 1C. The e-mail 50 is sent from a friend 56 of an individual 54 and may contain language such as “I recently came across this offer from Best Buy that I thought you may be interested in” along with a link 52 to the offer. In this embodiment the vendor sends the offer to the offerees specified by the user with the user's name and e-mail address in the sender field of the e-mail.

The offeree receives the offer by e-mail with the user's e-mail address or name 56 in the sender field. This identifies the source of the offer as a friend or acquaintance of the offeree. Because the e-mail comes from a friend or acquaintance of the offeree, the e-mail is more likely to not be filtered out by a spam filter. The e-mail also has a much greater chance of being read in detail because the offer comes from a friend or acquaintance of the offeree. The offeree will be considerably less reluctant to accept the offer because the offeree is familiar with someone who is currently a customer of the vendor specified in the offer.

The offer preferably comprises a message such as, “I am currently a subscriber to this magazine. I believe it may be of interest to you.” The message may also have language such as, “I have been enjoying this magazine and highly recommended it to you.” The message may also be customized by the user sending the message to the offeree. The message preferably also has a link to the vendor's website so that the offeree can simply click the link in the message and be directed to the vendor's website. The link preferably has identification information contained therein so that when the offeree clicks the link and is directed to the vendor's website, the vendor's website will recognize the offeree as a friend or acquaintance of the user. The offeree is preferably presented with a screen that says, “Welcome friend of [user].”

If the offeree accepts the offer from the vendor, the user who sent the offer to the offeree is rewarded a predetermined number of points. The points are awarded when the vendor system 20 provides the transaction information, such as what is purchased and the parties involved in the transaction, to the points system 40. Each user's points are tracked and maintained in the user database 42 in the points system. The points may be redeemed for different rewards depending on the preferences set by the vendor and the amount of points. For example, a certain number of points may be redeemed for additional products or services from the vendor. A vendor may accept points in conjunction with cash or credit card for the purchase of goods or services. Alternatively, points may be redeemed for monetary rewards, such as digital currency that may be used on other web sites.

When the offeree accepts the offer from the vendor, the offeree is invited to create a user profile in the user database. The offeree is now allowed to forward offers from the vendor to friends or acquaintances. If any friend or acquaintance of the offeree accepts any offer forwarded by the offeree, the offeree is awarded points that may be redeemed as discussed above.

The relationships established between users in the present invention are preferably permanent, meaning that points will accrue to the user for transactions entered into by the offeree months or even years after the original offer forwarded by the user. In alternative embodiments, the relationships may exist for only a predetermined amount of time and more time may be added if more relationships are created. The duration of relationships may also be set by a number of factors such as the value of past transactions or the number of past transactions.

The system provides marketing and advertisement for the vendor from users who have found the goods or services of the vendor to be useful. The users of the goods or services have incentive to properly search for and determine individuals who would likely be interested in the vendors goods or services because the user is rewarded points if the individuals the user recommends ultimately accept offers from the vendor. For example, if user 1 subscribes to a woodworking magazine, user 1 is likely to have friends or acquaintances that also partake in woodworking. User 1 recommends this magazine to those friends or acquaintances and will be rewarded if those friends accept an offer from woodworking magazine to become subscribers. This obviates the need for woodworking magazine to send mass e-mails or create Internet advertisements for their magazine which will reach a large number of people, only a small portion of which may be interested in woodworking. This method of marketing allows the vendor to reach individuals who may be interested in the products or services of the vendor without the vendor having to expend any money on advertisement.

The present invention improves over conventional marketing because the advertisements are not sent by a company. When an offeree is sent an offer, the offer comes from a friend or acquaintance of the offeree. Thus, the offeree will be more likely to read the offer because it was sent by someone who knows the offeree and is aware of the offeree's interests. The offeree is aware that the offer is specifically targeted, and not a general offer without any basis.

In one embodiment of the present invention, the vendor limits the amount of offers that any user may send. For example, a vendor who sells magazine subscriptions may allow any one subscriber to send a special offer from the vendor to any three friends of the subscriber. This prevents users from simply sending the offers to large numbers of people and instead encourages the users to send offers to only targeted individuals who are likely to be interested in the offer. After a predetermined time, if none of these offerees have accepted an offer, the vendor may allow the subscriber to send additional offers from the vendor. The subscriber may be allowed to send additional offers from the vendor based on the number of points that the subscriber has.

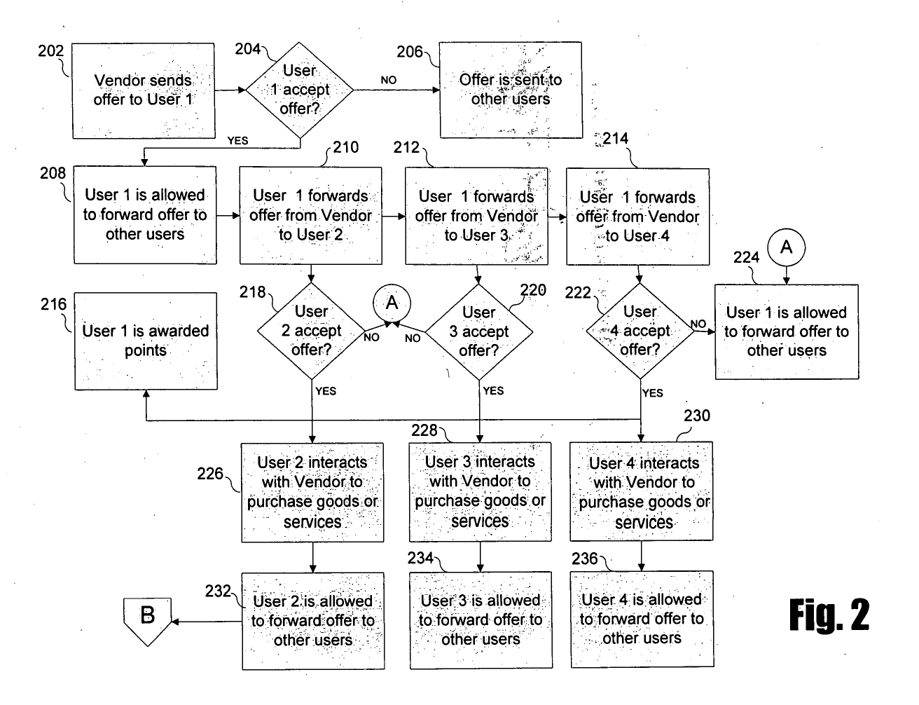

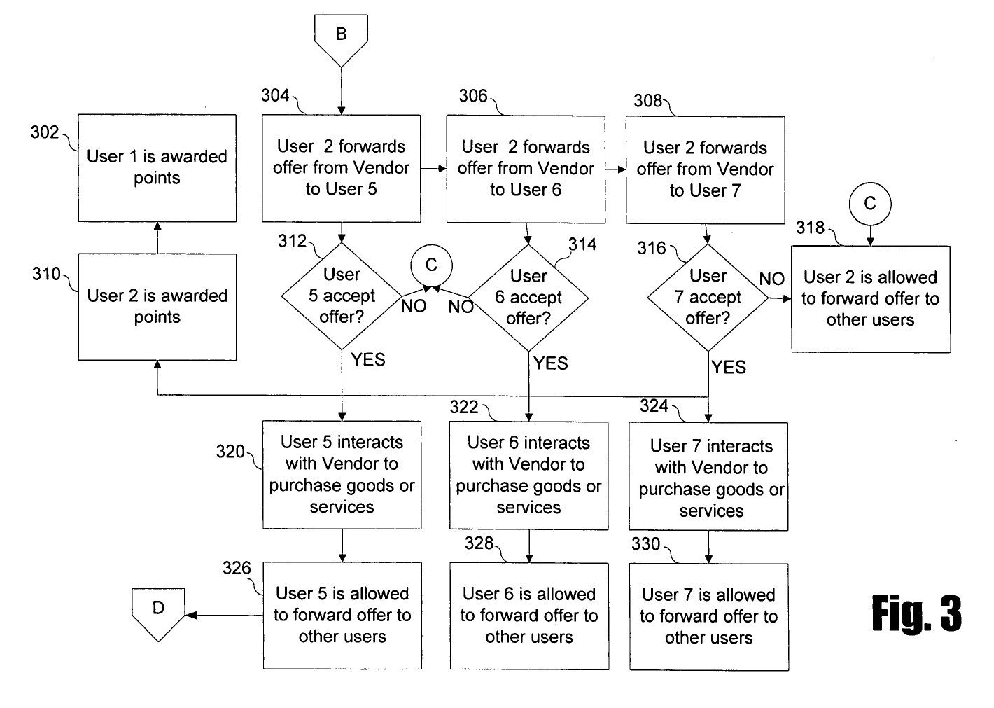

FIGS. 2 through 4 depict flow diagrams of one embodiment of a method according to the present invention. In the first step 202, a vendor sends an offer to User 1 or to a plurality of users. User 1 may accept the offer 204. User 1 need not purchase the offer, but may simply share the offer with friends or acquaintances 206 even if User 1 does not accept the offer. User 1 may then accept the offer for goods or services from the vendor. If User 1 does accept the offer, User 1 is allowed to forward the offer to other users 208. User 1 then forwards the offer from the vendor to offerees such as User 2, User 3 and User 4 as shown in steps 210, 212, and 214.

In a preferred embodiment, User 1 is notified by e-mail from the vendor when any individuals that User 1 forwarded an offer to accept the offer from the vendor. The e-mail preferably informs User 1 that they have been rewarded points because a user that they forwarded an offer to accepted the offer. The e-mail preferably contains the number of points awarded to User 1 and the name of the individual or the e-mail address of the individual that accepted the offer.

If none of these users accept the offer User 1 forwards from the vendor, User 1 is allowed to forward the offer to other users after a predetermined amount of time. If any of User 2, User 3, or User 4 accept the offer that User 1 forwards from the vendor as shown in 218, 220, 222, User 1 is awarded points 216. Then the user that accepts the offer from the vendor interacts with the vendor to purchase the goods or services described in the offer as shown in 226, 228, and 230. If one or more of User 2, User 3, or User 4 do not accept the offer, User 1 is allowed to forward the offer to other users 224. The user that purchases the goods or services is preferably invited to create a user profile which is stored in the user database 22. That user is then allowed to forward an offer from the vendor to other users, such as their own friends or acquaintances, as shown in 232, 234, and 236.

In a preferred embodiment, User 1 is rewarded points if any friends or acquaintances of User 2 accept an offer from the vendor that is sent by User 2. Thus, User 1 will be awarded points if User 5 accepts an offer sent by User 2. However, User 1 will not receive any points if User 5 sends an offer to User 8 and User 8 accepts. This is called the maximum level of depth: the amount of generations that points are awarded to. Although the preferred embodiment uses only two levels of depth, one skilled in the art would recognize that the maximum level of depth may be carried to any number of users depending on the preferences of the vendor.

In the flow diagram depicted in FIGS. 2-4, User 2 has accepted the offer forwarded by User 1. User 2 then forwards an offer from the vendor to User 5, User 6, and User 7 as shown in 304, 306, and 308. User 5, User 6, and User 7 are presented with the option of accepting the offer 312, 314, 316. If any of User 5, User 6, or User 7 accept the offer forwarded from User 2, User 2 is awarded points 310. In addition, because User 5, User 6 and User 7 were forwarded offers from User 2, and User 2 was forwarded an offer from User 1, User 1 will be awarded points 302 if any of User 5, User 6, or User 7 accept the offer from the vendor that was forwarded by User 2. If any of User 5, User 6, or User 7 do not accept the offer, User 2 is allowed to forward the offer to other users 318. If any of these users accept the offer from the vendor, they interact with the vendor to purchase goods or services as depicted in 320, 322, and 324. They are then allowed to forward offers to other users as shown in 326, 328, and 330.

In the present example, User 5 accepts the offer from the vendor which results in points being rewarded to User 2 310 and User 1 302.

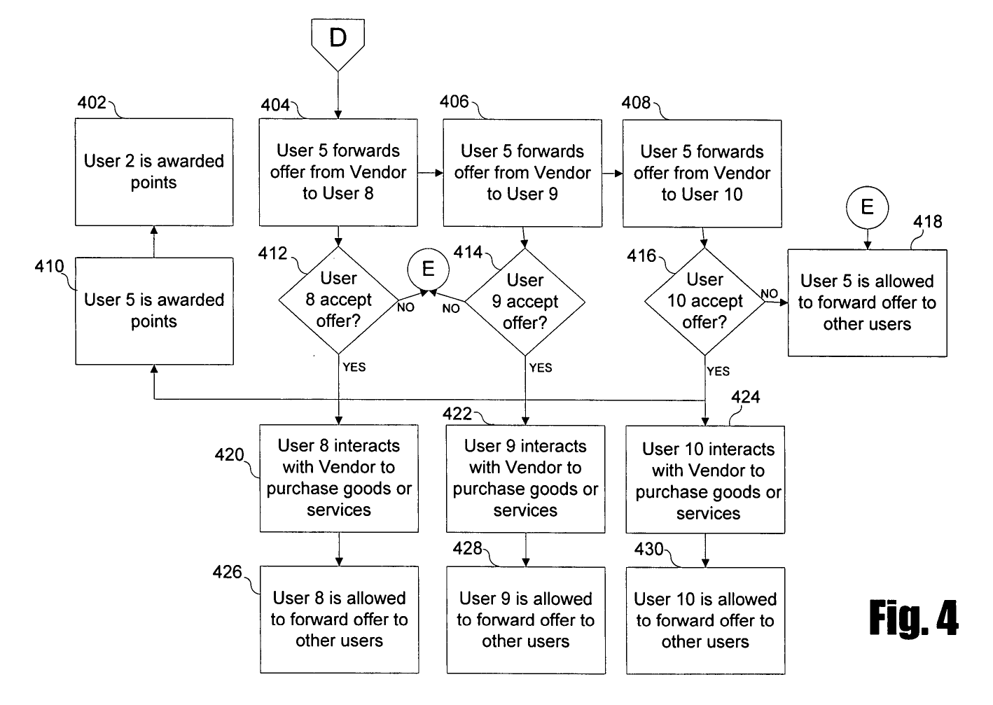

FIG. 4 depicts a flow diagram of steps that occur if User 5, who accepts an offer, decides to forward offers from the vendor to other users. In FIG. 4, User 5 forwards an offer from the vendor to Users 8, 9 and 10 as shown in 404, 406, and 408. If any of these users accept the offer from the vendor User 5 is awarded points 410 as well as User 2 402. In an alternate embodiment wherein the maximum number of generations to be awarded points is more than two, User 1 would also be awarded points. However, in this embodiment only two generations of users are awarded points.

Users 8, 9, and 10 are allowed to accept the offer 412, 414, 416 and will interact with the vendor to purchase goods or services if they choose to accept that offer 420, 422, 424. If they do not accept the offer, User 5 is allowed to forward the offer to other users 418. If any of User 8, User 9, or User 10 accept the offer, they are allowed to forward the offer or other offers from the vendor to other users 426, 428, 430.

FIGS. 2 through 4 only depict only a portion of a flow diagram according to the present method which would of course continue in the same manner if many users decide to accept offers from the vendor and also decide to send offers from the vendors to other users.

In another embodiment, User 1 is also rewarded points if any of User 2, User 3, or User 4 simply click a link in the offer to visit the vendor's website even though they do not accept the offer. This will preferably be a smaller amount of points than User 1 would be awarded if User 2, User 3, or User 4 had accepted the offer. The vendor however, may wish to reward User 1 simply for increasing awareness of the vendor's products or services and increasing traffic to the vendor's website.

A user may also be rewarded points based on the goods or services that offerees of the user accept. For example, if an offeree accepts an offer from a vendor to purchase a large volume of goods or services and makes additional purchases the user who sent the offer to the offeree may be rewarded points for all of the goods and services that the offeree purchases from the vendor.

The value of the rewarded points offered by a vendor is determined by the vendor, but is preferably not more than 100% of the value of the products or services sold. This ensures that the vendor can pay for the costs of goods and services and still receive a small profit or break even before providing the value of the rewards to a user.

In one embodiment, users are issued points cards from the vendor or points system that may be used as debit or credit cards with other merchants. The points system will keep track of how many points a user has accrued and authorize the points card to be charged a certain amount based on the amount of points in the user's account. For example, if a user has accrued 100 points, the vendor may authorize the user's points card to be debited 100 dollars. The user may then use this card to purchase goods or services from another vendor on the Internet or from a store that accepts credit/debit cards. Various vendors may all communicate with a single points system which allows for a central user database and easy update of points information.

In yet another embodiment, users are issued points cards as discussed above and the points themselves may be redeemable with the issuing vendor or with other vendors for goods or services. For example, vendor 1 may issue points cards and offer goods and services in exchange for points from vendor 2's or vendor 3's points cards. Alternatively, a group of vendors may add points to a common card that may be used with any of the vendors. A single central points system or numerous points systems may be used to implement these embodiments.

In lieu of issuing points cards, rewards, or currency to a user, a vendor may interact directly with a digital currency provider to convert a user's points into digital currency which is held in a user's account. The points can also be converted into standard currency in various denominations used throughout the world.

In one embodiment, the present system may work with a software plugin or desktop application that serves as a virtual wallet for the customer. The virtual wallet will keep track of how many points a user has and interact with online vendors in order to calculate an item's cost to the user in terms of points. If necessary, the wallet may also calculate how much money an item will cost a user in addition to the points stored in the user's wallet, and prompt the user for payment of the difference in the form of standard currency. The wallet may also execute the transaction for the purchaser by interacting with the online vendor, paying the online vendor using a payment program that deducts the points from the user's total and sends currency to the vendor. For example, if a user is viewing a book on BarnesAndNoble.com, the user may have a virtual wallet program that advises the user that the book would cost her $8.95 if she chose to pay with cash or 200 points if she chose to pay with points. The wallet may further compute how many points it would take to ship the book. If the user clicks on a “pay with points” button, the virtual wallet will interact with the entity that maintains the user's points as well as BarnesAndNoble.com to complete the transaction using only points.

Although this invention has been described with reference to e-mail, one skilled in the art would recognize that the invention may also be used with other methods of communication, such as instant messages or text messages. In one embodiment, a user may receive offers from a vendor in the form of text messages sent to a cell phone or other portable communications device, such as a Pocket PC, smart phone, or personal digital assistant. The offer may be forwarded to other users using similar devices and protocols or may alternatively contain a password or code that allows the offeree to redeem the offer at a store or on an Internet web site. It should be noted that in this embodiment, the invention operates on a large distributed network that may be separate and distinct from the Internet. Thus the present invention need not be operated on the Internet.

In a preferred embodiment, the vendor system works with the points system to provide recommendations to users for products or services based on previous purchases of the user or other users associated with the user (i.e., users that have accepted or provided offers to the user). For example, a vendor may send an e-mail to a user stating, “You have 100 points accumulated! You may want to redeem these points for a free 2-year subscription to woodworking magazine which your friends Ed and Samantha recently purchased!” The vendor system may search previous goods or services purchased by the user to determine similar products that the user may be interested in. The vendor system may work with the points system or other vendors to determine other products that the user has purchased in order to better gauge the user's purchasing preferences. In one embodiment, the system uses algorithms to recommend purchases based upon the purchasing histories of related individuals. The levels of separation of the individuals may be taken into account in the algorithm when recommendations are formulated.

The present system may also include a bulletin board which would allow users to post products that the users are interested in purchasing. In the preferred embodiment, only the employees of the points system are allowed to view these posted products. An employee of the points system may then solicit vendors for special offers based on these postings. The vendors may then submit special offers for these products to the points system for distribution to users or may distribute the offers themselves. Alternatively, an algorithm may be implemented which automatically requests a special offer from a vendor if a predetermined amount of posts are received for a particular product. In another embodiment, vendors are allowed access to the posted products and may be inclined to broadcast a special offer for a product if the product appears in numerous posts.

An example of the product posting system described above follows. A user “Bruce” may notice that many of his friends are thinking of buying plasma televisions. Bruce may then post a request for plasma television offers on the bulletin board. An employee of the points system will see the post and solicit vendors for plasma television offers. The vendors may check their inventory of plasma televisions and determine that it is feasible to offer a reduced price on certain televisions. The vendor may then transmit a special offer for plasma televisions to a plurality of users including Bruce. Bruce will then forward the offer to all of his friends that are interested in plasma televisions. If any of Bruce's friends accept the offer, Bruce will be awarded points. Alternatively, Bruce may accept the offer himself.

The present system may also include a searchable database of offers from vendors. This would allow a user to search for any outstanding special offers for a particular product. If the user finds a special offer that the user is interested in, the user may forward the offer to others or choose to accept the offer himself. For example, if user “Ed” recently had a conversation with a friend “Sam” in which Sam said that he was thinking of buying a new digital camera, Ed may search the system for special offers on digital cameras to forward to Sam. If Sam accepts one of the forwarded offers, Ed will be rewarded points. Thus, the search engine creates an incentive for users to search for special offers and transmit them to friends.

Although the invention herein has been described with reference to particular embodiments, it is to be understood that these embodiments are merely illustrative of the principles and applications of the present invention.

1. A computer-implemented method of marketing comprising:
sending a first offer for goods or services from a vendor over a network to a first user;
forwarding the first offer by the first user over the network to one or more first offerees;
awarding a first predetermined amount of points to the first user upon the one or more first offerees accepting the first offer from the vendor;
forwarding a second offer by the one or more first offerees to one or more second offerees; and
awarding the one or more first offerees and the first user a second predetermined amount of points upon one or more second offerees accepting the second offer.

2. The method of claim 1, further comprising the first user redeeming the points for goods or services from the vendor.

3. The method of claim 1, further comprising the first user redeeming the points for currency.

4. The method of claim 1, further comprising providing a code number with the first offer such that the first offer can be traced back to the first user if any of the first offerees accept the first offer.

5. The method of claim 1, further comprising restricting the first user to forwarding the offer to a predetermined number of first offerees.

6. The method of claim 1, further comprising calculating the first predetermined amount of points using the value of the goods or services purchased.

7. The method of claim 1 further comprising:
designating any user from the second set of offerees that accepts the second offer the third user;
forwarding a third offer by the third user from the vendor to a third set of offerees comprising one or more offerees; and
awarding a third predetermined number of points to the second user and the third user if any offeree from the third set of offerees accepts the third offer from the vendor.

8. The method of claim 7 further comprising:
awarding a predetermined number of points to the first user if any offeree from the third set of offerees accepts the third offer from the vendor.

9. The method of claim 1, further comprising:
creating a user profile by the first user containing information about the user, and
storing the user profile.

10. The method of claim 9, further comprising:
creating a user profile by any one of the first offerees or the second offerees upon acceptance of the first offer or the second offer from the vendor, and
storing the user profile.

11. A system for marketing comprising:
a vendor computer including a processor programmed to offer products or services to a plurality of users over a network;
a points computer including a processor programmed to communicate with the vendor computer over the network, record profiles and transaction histories for at least one user, and enable the at least one user to send offers for goods or services from the vendor computer to a group of users.

12. The system of claim 11, wherein the processor of the points computer is further programmed to award points to a user if the user sends an offer for goods or services to a second user that accepts the offer.

13. The system of claim 11, wherein the processor of the vendor computer is programmed to communicate with the at least one user through a web site.

14. The system of claim 11, wherein the processor of the points computer is programmed to award points based on the dollar value of the goods or services sold.

15. The system of claim 11, wherein the processor of the vendor computer is programmed to provide recommendations for goods or services to the at least one user based on the transaction history of the at least one user.

16. The system of claim 11, wherein the processor of the vendor computer includes a database of offers, the database being searchable by the at least one user.

17. The system of claim 11, further comprising a debit card which stores a value corresponding to the amount of points the at least one user has in his or her account.

18. The system of claim 11, further comprising a credit card that causes the deduction of points from the at least one user's account when used for purchases.

19. A computer-implemented method of marketing comprising:
sending a first offer for goods or services from a vendor computer to a first user,
accepting the first offer from the vendor computer by the first user,
forwarding the first offer from the vendor computer to one or more first offerees from the first user,
accepting the first offer by one or more first offerees from the vendor computer,
awarding a first predetermined amount of points to an account on a points computer corresponding to the first user if the one or more first offerees accepting the first offer,
forwarding a second offer by the first offerees from a vendor computer to one or more second offerees, and
awarding the one or more first offerees and the first user a second predetermined amount of points to an account on a points computer upon one or more second offerees accepting the second offer.

20. A system for marketing comprising:
a vendor computer including a processor programmed to offer products or services to a plurality of users over a network,
wherein the vendor computer is adapted to store profiles for the plurality of users including information about the users and prior transactions conducted by the users, and
the processor of the vendor computer is adapted to send offers for goods or services from a selected user of the plurality of users to offerees and awards points to the selected user if any of the offerees accept the offer.

21. A storage medium storing a program executable by a processor, wherein the program causes the processor to:
send a first offer for goods or services from a vendor over a network to a first user;
forward the first offer from the first user over a network to one or more first offerees; and
award a first predetermined amount of points to the first user upon the one or more first offerees accepting the first offer from the vendor;
wherein the offerees can forward a second offer to one or more second offerees; and
awarding the one or more first offerees and the first user a second predetermined amount of points upon one or more second offerees accepting the second offer.
